(19) United States
(12) Patent Application Publication
(10) Pub. No.: US 2016/0035154 A1
(43) Pub. Date: Feb. 4, 2016

(54) Bus Monitoring System to Detect Driver Alertness and Enhance Passenger Safety

(71) Applicants: Jose Octavio Lejarza, McAllen, TX (US); Leopoldo Barrera, McAllen, TX (US)

(72) Inventors: Jose Octavio Lejarza, McAllen, TX (US); Leopoldo Barrera, McAllen, TX (US)

(21) Appl. No.: 14/811,568

(22) Filed: Jul. 28, 2015

Related U.S. Application Data
(60) Provisional application No. 62/030,358, filed on Jul. 29, 2014.

(51) Int. Cl. G07C 5/02; B60R 1/00; G01C 19/00; G06K 9/62; G01P 15/00; G01S 19/01; G06K 9/00

(52) U.S. Cl. CPC G07C 5/02; G01S 19/01; B60R 1/008; G06K 9/00845; G06K 9/6201; G06K 9/00838; G01P 15/00; G01C 19/00; B60R 2300/8006

(57) ABSTRACT

A vehicle monitoring system to detect driver alertness and enhance passenger safety is provided. The system includes a global positioning system connected to the bus and able to generate positioning data associated with the bus, an accelerometer gyroscope connected to the bus and able to generate 3-axis acceleration, heading, roll and yaw data associated with the bus, a plurality of vision sensors connected to the bus and able to generate passenger data associated with the bus, and a computing device affixed to the bus and able to store and transmit the positioning data, 3-axis acceleration data, heading data, roll data, yaw data, passenger data, bus compartment access data, and driver identification data to a central server via a communication device to enable an analysis to detect driver alertness and enhance passenger safety.

### CROSS REFERENCES TO RELATED APPLICATIONS

This application claims the benefit of and priority to U.S. Provisional Patent Application Ser. No. 62/030,385, filed Jul. 29, 2014 and entitled Bus Monitoring System to Detect Driver Alertness and Enhance Passenger Safety, which is incorporated by reference herein.

### FEDERALLY SPONSORED RESEARCH OR DEVELOPMENT

Not applicable.

### BACKGROUND OF THE INVENTION

1. Field of the invention

The present invention relates generally to commercial vehicles such as buses, which are used to transport passengers.

2. Description of the Related Art.

Commercial vehicles are frequently used in public transportation, distribution of goods and services, exploration, and other applications. The term vehicle includes, but is not limited to: wagons, bicycles, motor vehicles (motorcycles, cars, trucks, buses), railed vehicles (trains, trams), watercraft (ships, boats), snowcraft, aircraft and spacecraft. A number of problems frequently arise when using commercial vehicles. These problems include: driver fatigue, unauthorized passengers, and unauthorized travel. Until now, commercial vehicle users have been generally limited in terms of the methods available for addressing such issues. The methods include: recording trips using audio visual equipment; or manually inspecting the vehicle hoping to detect any problems and using a cell phone, pager or other device to manually alert a third party of any problems that arise.

These methods are often inadequate. When users record the trip audio visual equipment, the user may never actually detect a problem, and if the user does detect a problem, detection is often long after the problem occurs because the user's primary focus is to operate the vehicle. At best, a third party receives a delayed transmission of the recording possibly notices the problem if observed. Even if the third party notices the problem, there is often nothing that can be done immediately to solve the problem.

The method of manually inspecting the vehicle is best performed before and after transit as this method does not require the user to compromise his primary focus of operating the vehicle. Of course, manual inspection before and after transit often premature or delayed. Similarly, if the user notifies a third party of a problem, there is often nothing that can be done immediately to solve the problem. Additionally, a user may not see everything—a fallback resulting from human error.

The present invention eliminates these problems, as well as others. The present invention through various embodiments is intended to be used in commercial vehicles. The present invention in various embodiments uses a variety of hardware and software to detect attributes of the vehicle and/or humans aboard the vehicle. The present invention receives those attributes and compares the attributes with predetermined acceptable values and determines whether a third party should be notified, and/or other action should be taken. Because of the present invention's improvement over existing methods, the present invention acts closer to real time. Elements associated with various embodiments include: bus automation computer; data acquisition card; sensors; compartment locking actuators; 3-axis accelerometer/gyroscope; GPS device; driver identifier; internet access device; inductive proximity sensors; driver touch interactive display; bus control software; central server software; dispatch control software; machine vision processing software; centralized database system; main system server; dispatch computers; relays; electronics control enclosure; DC power supply; and driver alertness alarm. Of course, the methods disclosed herein may be carried out with any combination of elements listed above or other elements not mentioned but otherwise known in the art. As a result of these components, or combinations, modifications and variations thereof, the present invention is an effective commercial vehicle monitoring system.

### BRIEF SUMMARY OF THE INVENTION

A bus monitoring system to help enforce Department Of Transportation compliance, detect accidents, unscheduled stops, unauthorized bus compartment access, undesired driving behavior, driver alertness and enhance passenger safety is provided. The system comprises a global positioning system operably connected to the bus and configured to generate positioning data associated with the bus, an accelerometer/gyroscope operably connected to the bus and configured to generate 3-axis acceleration data as well as heading, roll, and yaw data associated with the bus, a plurality of vision sensors operably connected to the bus and configured to generate passenger data associated with the bus, a vision sensor operably connected to the bus and configured to generate driver alertness data, a plurality of proximity sensors operably connected to the bus in a distributed manner and configured to generate bus compartment access status, a driver identification device operably connected to the bus and configured to identify the driver and log driving time, and a computing device affixed to the bus and configured to store and transmit the positioning data, acceleration data, driving behavior data, driver data, bus compartments data and passenger data to a central server via a communication device to enable an analysis to detect driver alertness and enhance passenger safety. The central server will send alerts and real time status data to all dispatch connected clients and registered email addresses. In view of the foregoing, the principal object of the present invention is to provide a system for determining whether the driver of a vehicle is sufficiently alert, and taking corrective action if necessary.

It is another object of the present invention to provide a system for determining the position of the vehicle and deciding whether the vehicle is within an authorized area, and taking corrective action if necessary.

It is another object of the present invention to provide a system for determining whether the number of passengers aboard a vehicle is consistent with the number of passengers authorized to ride the vehicle, and taking corrective action if necessary.

It is another object of the present invention to provide a system for allowing a driver to request vehicle compartments be opened if previously locked wirelessly by a third-party operator.

It is another object of the present invention to provide a system for determining whether the g-force exhibited on the vehicle is within an acceptable limit, and taking corrective action if necessary.

It is another object of the present invention to provide a system for determining whether the roll, yaw, and/or heading of the vehicle are within their acceptable limits, and taking corrective action if necessary.

These and other objects and advantages of the present invention will become apparent o one skilled in the art from the detailed description of the invention and the claims, with it understood that other configurations or substitutions of material may be used and are included within the scope of the claims of this invention.

### BRIEF DESCRIPTION OF THE SEVERAL VIEWS OF THE DRAWINGS

FIG. 1 a schematic diagram of a vehicle monitoring system in accordance with certain embodiments of the present invention.

FIG. 2 a flowchart of a process of a vehicle monitoring system in accordance with some implementations of the present invention.

FIG. 3 is a flowchart of an alternate process of a vehicle monitoring system in accordance with some implementations of the present invention.

FIG. 4 is a flowchart of an alternate process of a vehicle monitoring system in accordance with some implementations of the present invention.

FIG. 5 is a flowchart of an alternate process of a vehicle monitoring system in accordance with some implementations of the present invention.

FIG. 6 is a flowchart of an alternate process of a vehicle monitoring system in accordance with some implementations of the present invention.

FIG. 7 is a flowchart of an alternate process of a vehicle monitoring system in accordance with some implementations of the present invention.

### DETAILED DESCRIPTION OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the description is to he regarded in an illustrative, rather than a restrictive, sense.

The detailed descriptions that follow are presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware and software is not always sharp, it being understood by those skilled in the art that the software implemented processes described herein may be embodied in hardware, firmware, software, or any combination thereof. Such processes may be controlled by coded instructions such as in microcode and/or in stored programming instructions readable by a computer or processor.

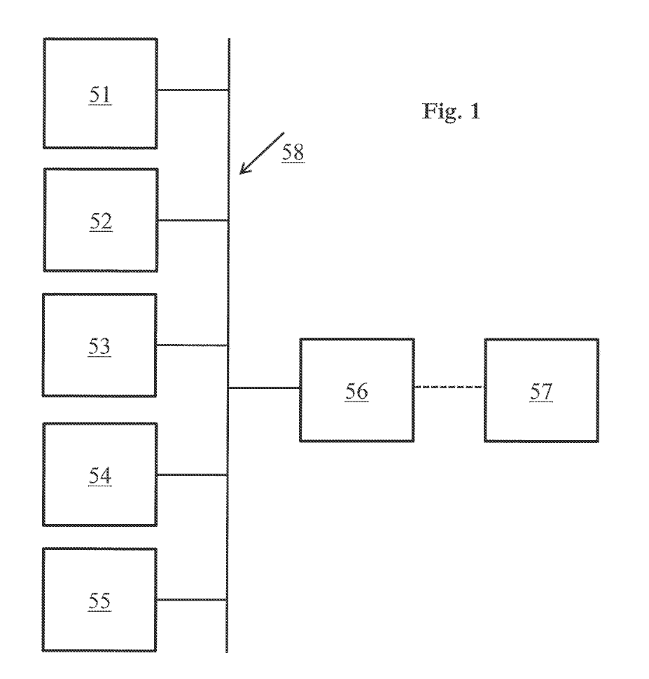

FIG. 1 shows a diagram of various components of a vehicle monitoring system and some of their connections. Specifically, FIG. 1 illustrates multiple devices for measuring data, including: a GPS device 51, an accelerometer/gyroscope 52, one or more vision sensors 53, one or more proximity sensors 54, and an identification device 55. FIG. 1 further shows the multiple devices for measuring data 51, 52, 53, 54, 55 connected to a vehicle bus 58. The vehicle bus 58 is also connected to a central server 56, which analyzes the data received from the multiple devices for measuring data 51, 52, 53, 54, 55. When the central server 56 recognizes values received from the multiple devices for measuring data 51, 52, 53, 54, 55 exceed the acceptable values as provided in the centralized database system (not illustrated), the central server 56 sends an alert to an alert terminal 57. The alert terminal may be physically connected to the central server 56, or wirelessly. As for the centralized database system, a customer and/or user may supply updated information/data values for improved performance of the system. The values supplied by customer are modifiable.

In various embodiments of the invention, there exists a Bus Automation Computer that runs a Bus Control Software, which receives driver vision data, passenger vision data, and physical bus status and motion dynamics data. The Bus Control Software makes decisions based on analog and digital data received from a Data Acquisition Card. The Data Acquisition Card receives data in the form of voltage from one or more Inductive Proximity Sensors which turns on or off the signal sent to the Data Acquisition Card based on the detection of bus parts which move when the compartments are either open or closed. Vehicle compartments include, but are not limited to storage/cargo spaces, engine banks, restrooms, cabins, and the vehicle as a whole.

In some embodiments, one or more Driver Vision Sensor(s) monitor a driver/operator when the vehicle is moving, looking for cues and indicators that suggest low driver alertness. The Driver Vision Sensor(s) provide data to the Bus Automation Computer, which uses and runs Machine Vision Processing Software to provide logical variables to the Bus Control Software, which analyzes data and reacts when it detects a low driver alertness level based on parameters specified in a Centralized Database System. A Driver Alertness Alarm activates when it detects a low driver alertness level based on parameters specified in the Centralized Database System.

The Driver Vision Sensor(s) gather and evaluate biometric values and compare them with acceptable values from Centralized Database System. The Driver Vision Sensor(s) further account for driving time for compliance with commercial and other governing authorities.

In certain embodiments, one or more Passenger Vision Sensor(s) send data to the Bus Automation Computer, which uses and runs the Machine Vision Processing Software to provide logical variables to the Bus Control Software, which analyzes data and sends a passenger count to Central Server Software, which is running on a Main System Server. The Central Server Software saves data to the Centralized Database System and notifies all appropriate devices running Dispatch Control Software of information regarding the passenger count.

In some embodiments, a GPS Device sends real-time global positioning data of the bus to the Bus Automation Computer, which by means of the Bus Control Software sends current bus location to the Centralized Database System. A Precision 3-Axis Accelerometer/Gyroscope sends real-time acceleration data in 3 axes, as well as gyroscope and compass data to the Bus Automation Computer, which uses Bus Control Software to perform an analysis of the data. Specifically, bus driving dynamics are analyzed and sent to the Main System Server and logged in the Centralized Database System.

In operation, the Driver Vision Sensor(s), together with the Precision 3-Axis Accelerometer/Gyroscope provides data to the Bus Control Software both directly and via the Machine Vision Processing Software. The Bus Control Software detects low driver alertness based on data stored in the Centralized Database System. The precision 3-Axis Accelerometer/Gyroscope sends data to the Bus Control Software, which monitors and detects driving behavior and special events like accidents or collisions. Events are detected based on queries made to the Centralized Database System where event definitions are stored. Inductive Proximity Sensors send data to the Bus Control Software via the Data Acquisition Card, which detects when a bus compartment is opened. The Bus Control Software then sends data to the Central Server Software, which logs the event and notifies the Dispatch Control Software. The Central Server Software is the only element that has direct access to the Centralized Database System. Both the Bus Control Software and the Dispatch Control Software connect to the Central Server Software by means of a proprietary internet protocol.

Data transmissions between the Bus Automation Computer and the Main System Server are completed by means of an Internet Access Device. An Electronics Control Enclosure stores a DC Power Supply, the Data Acquisition Card, and one or more Relays. Dispatch Control Software runs on one or more Dispatch Computers, Machine Vision Processing Software runs on the Bus Automation Computer and sends Driver Vision Sensor(s) and Passenger Vision Sensor(s) data to the Bus Control Software. The Central Server Software receives information from the Bus Control Software and saves data to the Centralized Database System. A Driver Identifier is connected to the Bus Automation Computer. One or more Compartment Locking Actuators are connected to the Relays, which are controlled by the Data Acquisition Card. A Driver Touch Interactive Display is connected to the Bus Automation Computer and displays the Bus Control Software screens. This allows the driver to request and send alerts to the Dispatch Control Software.

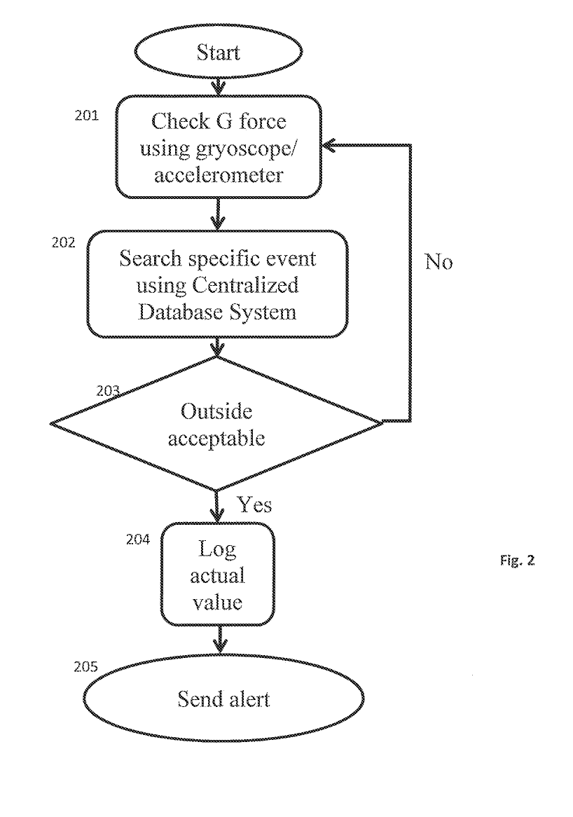

FIGS. 2-7 illustrate several examples of logic implemented by the vehicle operating system during an analysis of relevant data. For instance, FIG. 2 illustrates the gyroscope/accelerometer measuring G-forces exerted on the vehicle during use 201. After a measurement is taken, it is compared with the acceptable range of G-forces as provided by the customer/user in the Centralized Database System 202, The method then determines whether the measurement is within the acceptable range of G-forces in the Centralized Database System 203. If the measurement is acceptable, the initial measurement 201 and comparison 202 steps are repeated. If, however, the measurement is not acceptable, the value might be logged 204. Next, an alert is sent to either a system operator or the driver/operator 205. The alert indicates that the vehicle has left the acceptable range for G-forces. On practical level, such an alert might indicate a sudden breaking or acceleration. Application may arise for mass transit vehicles, or luxury transit such as limousines, where the commercial transportation provider boasts smooth transportation.

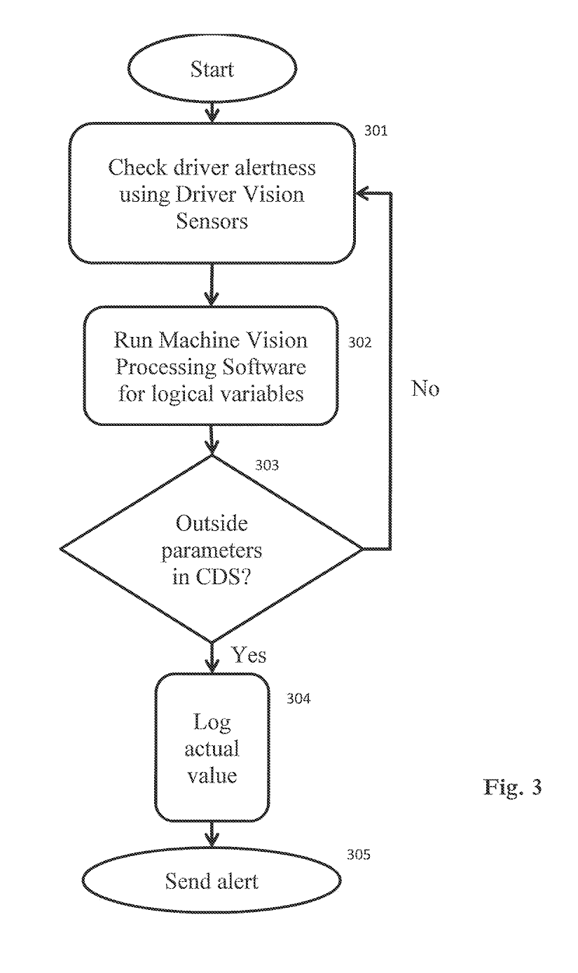

FIG. 3 illustrates the Driver Vision Sensors checking driver attributes for alertness 301. The method then runs Machine Vision Processing Software for logical variables 302 and determines whether the driver's attributes (as analyzed through logical variables) are outside parameters specified in the Centralized Database System 303. If the measurement is within the specified parameters, the initial measurement 301 and the running of the Machine Vision Processing Software are repeated. If, however, the measurement is not within parameters, the measurement might be logged 304. Next, an alert is sent o either a system operator or the driver/operator 305. The alert indicates that the driver/operator is not sufficiently alert.

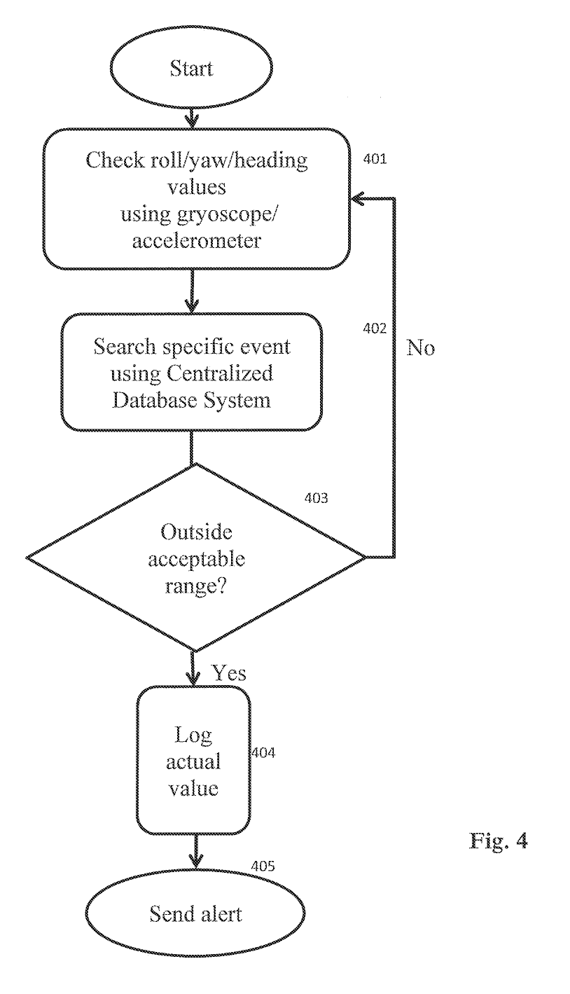

FIG. 4 next illustrates the gyroscope/accelerometer measuring roll, yaw/heading values exhibited by the vehicle during use 401. After a measurement is taken, it is compared with the acceptable range of roll, yaw, and heading values as provided by the customer/user in the Centralized Database System 402. The method then determines whether the measurement is within the acceptable range of roll, yaw/heading values in the Centralized Database System 403. If the measurement is acceptable, the initial measurement 401 and comparison 402 steps are repeated. If, however, the measurement is not acceptable, the value might be logged 404. Next, an alert is sent to either a system operator or the driver/operator 405. The alert indicates that the vehicle has left the acceptable range for roll, yaw/heading values. On a practical level, such an alert might indicate a sharp turn or unsteadiness in the vehicle. Application may arise for mass transit vehicles, or luxury transit such as limousines, where the commercial transportation provider requires smooth transportation.

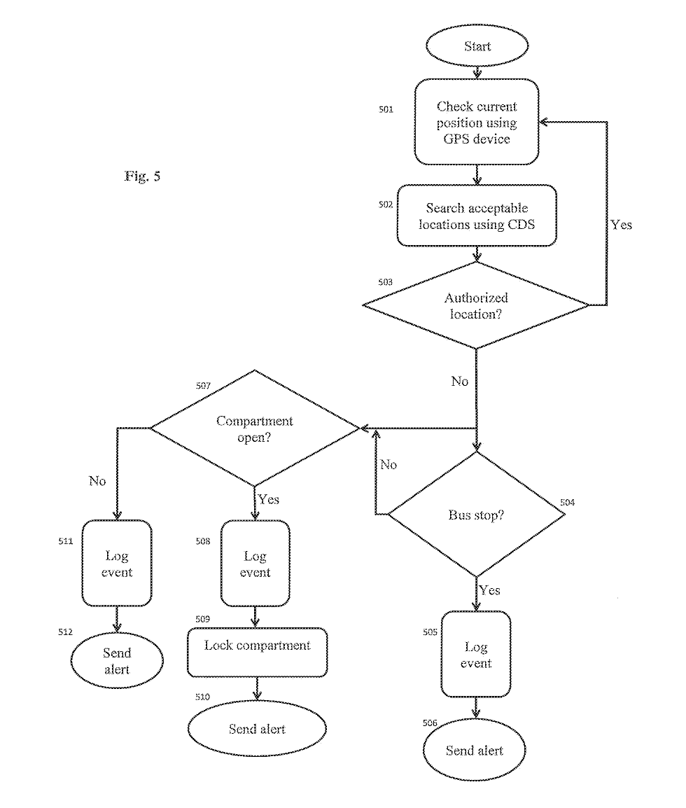

FIG. 5 illustrates the GPS device measuring the position of the vehicle 501. After the position is measured, it is compared with the acceptable field of locations as provided by the customer/user in the Centralized Database System 502. The method then determines whether the measurement is within an authorized location in the Centralized Database System 503. If the measurement is acceptable, the initial measurement 501 and comparison 502 steps are repeated. if the vehicle is not in an authorized location, the system determines whether the vehicle has come to a stop 504. If the vehicle has come to a stop, it is logged that the vehicle is not in an authorized location and that the vehicle has come to a stop 505. Once the log is performed, an alert is sent to either a system operator or driver/operator 506. The alert indicates that the vehicle is not in an authorized location, and that the vehicle has come to a stop. If the system determines the vehicle is not in an authorized location, the system also inquires whether a compartment is open 507. The user/customer predetermines which compartments should be evaluated. Additionally, if the bus has not stopped 504 the system determines whether a compartment is open 507. If the compartment(s) is open, it is logged that the vehicle is not in an authorized location and that the compartment is open 508. Once the log is performed, the compartment(s) is then locked using Compartment Locking Actuators 509. Then an alert is sent to either a system operator or the driver/operator 510. The alert indicates that the vehicle is not in an authorized location, and that the compartment(s) have been locked. Lastly, if the compartment(s) is locked, the system logs that the vehicle is not in an authorized location and that the compartment(s) was already locked 511. After the system makes the log 511, an alert is sent to either a system operator or the driver/operator regarding same 512.

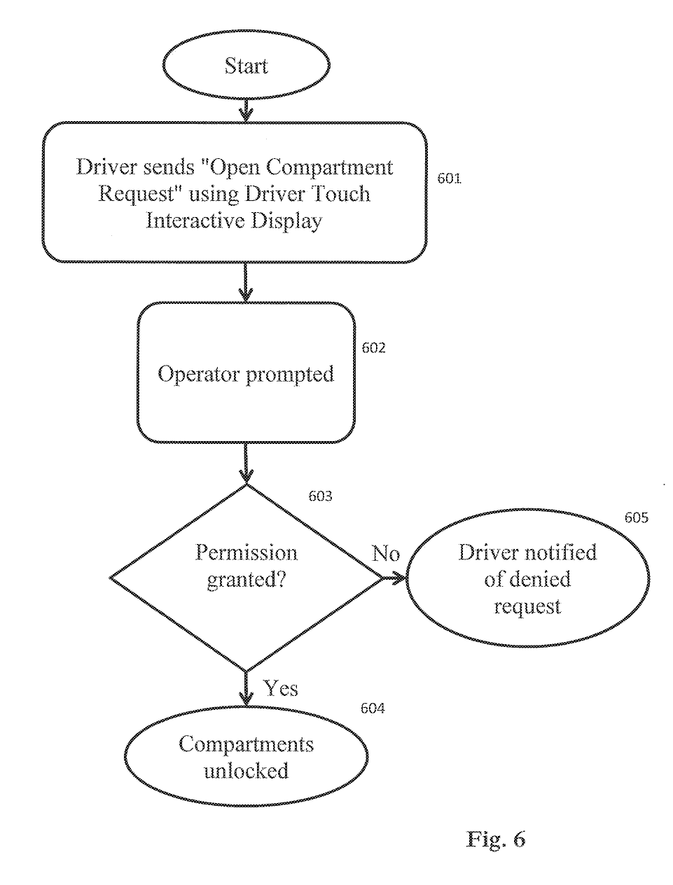

FIG. 6 illustrates an embodiment where a driver/operator is operating a vehicle with a locked compartment(s) and requests the compartment(s) be unlocked. As illustrated the driver operator sends an “Open Compartment Request” using a Driver Touch Interactive Display 601. A system operator is then prompted with the “Open Compartment Request” 602. The system operator then decides 603 whether to grant the “Open Compartment Request” 601. If the system operator grants the “Open Compartment Request” 602, the compartments are unlocked 604. If, however, the system operator decides to deny the “Open Compartment Request” 602, the system operator sends the driver/operator notification of the denied request 605.

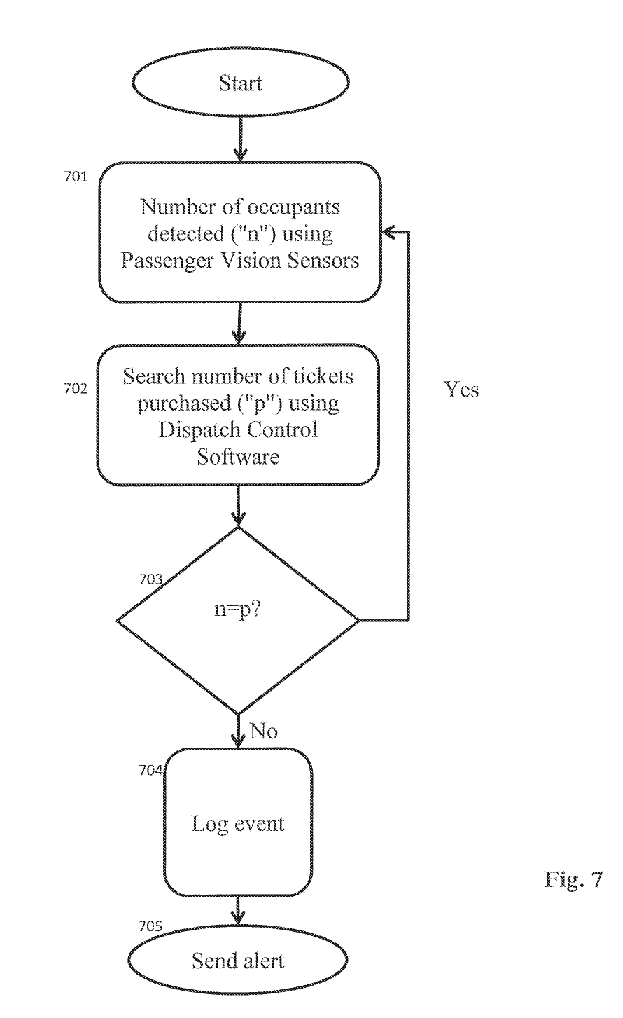

FIG. 7 illustrates the Passenger Vision Sensor(s) checking the number of occupants aboard the vehicle 701. The method then runs Dispatch Control Software to determine the number of tickets purchased, or how many occupants should otherwise be present 702. The system then determines whether the number of occupants present and the number of occupants that should be aboard are the same 703. If the number of occupants exceeds the number occupants that should be present, then the system logs the discrepancy 704. After the system logs the discrepancy, an alert is sent to either a system operator or the driver/operator 705.

It shall be appreciated that drivers will use the system by logging in and logging out before and after each trip. The drivers will also use the system by interacting with the Driver Touch Interactive Display to request bus compartments to be opened, or send one or more emergency alerts. Administrative personnel will enter new data and definitions into the system by using the Dispatch Control Software. Assigned personnel will se the system to receive alerts when an anomaly is detected. Such anomalies may consist of a disparity between actual passenger count and tickets sold, low driver alertness being detected, an emergency alert being received, or an alert of bus compartments being opened.

Persons of ordinary skill in the art ay appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

It shall be appreciated that the components of the vehicular alert system described in several embodiments herein may comprise any known materials in the field and be of any color, size and/or dimensions. It shall be appreciated that the components of the vehicular alert system described herein may be manufactured and assembled using any known techniques in the field.

Although the present invention has been described in large part with respect to automobiles/passenger vehicles, one of ordinary skill in the art will recognize the present invention has broader application. This invention may be adopted in various applications where one or more passengers not limited to humans may occupy a fixed space for transportation and related activities. Such applications include but are not limited to motor vehicles (e.g., cars, trucks, buses, trains), watercraft (e.g., ships, boats), spacecraft and aircraft.

In an alternative embodiment, the invention may comprise nonvisual spectrum illumination (e.g., IR/NIR) in order to stabilize visual data intensity. Moreover, the sensor would also utilize appropriate filters. Accordingly, such an embodiment allows the system to detect with greater certainty, regardless of whether the invention is engaged under light or dark (i.e., day or night) conditions.

In another embodiment, the invention might not engage a CAN bus (depending in large part on the particular vehicle), as illustrated in Attachment “B.” This possibility is apparent given the various methods of communicating and/or activating vehicular life support systems such as air conditioning or heating. Alternatives might include using other protocols or communication buses; or directly closing a switch/circuit.

Persons of ordinary skill in the art will appreciate that numerous design configurations may be possible to enjoy the functional benefits of the inventive systems. Thus, given the wide variety of configurations and arrangements of embodiments of the present invention the scope of the invention is illustrated by the claims below rather than narrowed by the embodiments described above.

The present invention is described above in terms of a preferred illustrative embodiment of a specifically described vehicle operating system that detects lack of alertness by operators, passenger data, and motion dynamics data, as well as alternative embodiments of the present invention. Those skilled in the art will recognize that alternative constructions and implementations of such a system can be used in carrying out the present invention. Other aspects, features, and advantages of the present invention may be obtained from a study of this disclosure and the drawings, along with the appended claims.

We claim:

1. A method for promoting vehicular safety, comprising:
a. operating a vehicle;
b. engaging one or more vision sensors operably connected to a computer bus of the vehicle;
c. receiving data from the vision sensor(s);
d. comparing the data of the vision sensor(s) with a predetermined values; and
e. if each of the datum of the vision sensor(s) are within the predetermined values, repeat steps c-d; and
f. sending an alert.

2. The method of claim 1 further comprising the step of recording the data of the vision sensor(s) that was not within an acceptable value.

3. The method of claim 1 wherein the alert is sent to a system operator.

4. The method of claim 1 wherein:
a. the vision sensor(s) is a driver vision sensor(s); and
b. steps 1b-1d involve comparing the data received from the vision sensor(s) with a set of parameters from a centralized data base system for low driver alertness.

5. The method of claim 1 wherein:
a. the vision sensor(s) is a driver vision sensor(s);
b. steps 1b-1d involve comparing the data received from the vision sensor(s) with a log of how much time the driver has spent driving; and
c. the predetermined set of acceptable values is maximum permissible driver time for a certain period of time preceding step 4c.

6. The method of claim 1 wherein:
a. the number of passenger tickets sold is counted;
b. the one or more vision sensors are passenger vision sensors;
c. the one or more vision sensors count the number of passengers aboard the vehicle; and
d. the predetermined set of acceptable values is the number of passenger tickets sold.

7. A method for promoting vehicular safety, comprising:
a, operating a vehicle;
b. engaging a GPS device operably connected to a computer bus of the vehicle;
c. receiving data from the GPS device;
d. comparing the data received from the GPS device with a predetermined values;
g. if each of the datum received from the GPS device are within the predetermined set of acceptable values, repeat steps c-d; and
h. sending an alert.

8. The method of claim 7 further comprising the step of recording the data of the GPS device that was not within an acceptable value.

9. The method of claim 7 wherein the alert is sent to a system operator.

10. The method of claim 7 further comprising:
a. the step of determining whether one or more compartments are open;
b. if no compartments are open, repeat step a; and
c. sending an alert.

11. The method of claim 10 wherein one or more open compartments are locked if it is determined in step 10a that one or more compartments are open.

12. The method claim 11 wherein:
a. a driver may send an open compartment request;
b. an operator is prompted with the open compartment request;
c. the may operator may grant the open compartment request, which opens the locked compartment(s), or the operator may deny the open compartment request.

13. A vehicle monitoring system, the system comprising:
a global positioning system operably connected to a vehicle bus and configured to generate positioning data associated with the bus;
an accelerometer/gyroscope operably connected to the vehicle bus and configured to generate 3-axis acceleration data, roll data, and yaw data, each associated with the vehicle;
a plurality of vision sensors operably connected to the vehicle bus and configured to generate passenger data associated with the vehicle;
a plurality of proximity sensors operably connected to the vehicle bus and configured to generate vehicle compartment access data;
a driver identification device operably connected to the vehicle bus and configured to provide driver identification data and to log driving time; and
a computing device operably connected to the vehicle bus and configured to store and transmit the positioning data, 3-axis acceleration data, heading data, roll data, yaw data, passenger data, bus compartment access data, and driver identification data to a central server via a communication device.

14. The vehicle monitoring system of claim 13 further comprising an alert system operably connected to the vehicle bus.
